(19) United States
(12) Patent Application Publication
(10) Pub. No.: US 2016/0369154 A1
(43) Pub. Date: Dec. 22, 2016

(54) DOWNHOLE STRUCTURES INCLUDING SOLUBLE GLASS

(71) Applicants: Michael H. Johnson, Katy, TX (US); Anil Sadana, Houston, TX (US); Suman Khatiwada, Houston, TX (US)

(72) Inventors: Michael H. Johnson, Katy, TX (US); Anil Sadana, Houston, TX (US); Suman Khatiwada, Houston, TX (US)

(73) Assignee: Baker Hughes Incorporated, Houston, TX (US)

(21) Appl. No.: 15/157,932

(22) Filed: May 18, 2016

Related U.S. Application Data
(60) Provisional application No. 62/181,144, filed on Jun. 17, 2015.

(51) Int. Cl. C09K 8/504; C03C 13/00; C03C 8/02; C03C 8/24; E21B 33/13; E21B 43/267

(52) U.S. Cl. CPC C09K 8/504; E21B 33/13; E21B 43/267; C03C 8/02; C03C 8/24; C03C 13/00; E21B 43/26

(57) ABSTRACT

A downhole material and a soluble glass dispersed within the material. A method for operating in a borehole.

### CROSS REFERENCE TO RELATED APPLICATIONS

This application claims the benefit of an earlier filing date from U.S. Provisional Application Ser. No. 62/181,144 filed Jun. 17, 2015, the entire disclosure of which is incorporated herein by reference.

### BACKGROUND

In the drilling and completion industry, there is often need for structures to have a first function and then a second or are required to be removed altogether. Tools and materials that are required to block flow and hold pressure for one operation become a hindrance to subsequent operations necessitating their removal from the borehole potentially requiring a separate run or their modification that similarly may require a separate run or at least an additional operation or operations. The art would well receive alternatives that increase efficiency.

### BRIEF DESCRIPTION

A downhole material includes a soluble glass dispersed within the material.

A method for operating in a borehole includes disposing a downhole material including a soluble glass dispersed within the material in a borehole; performing an operation in the borehole; allowing sufficient time for the soluble glass to dissolve; performing a different operation in the borehole without taking an action to change the material.

A downhole fluid includes one or more fluid components; and soluble glass.

### BRIEF DESCRIPTION OF THE DRAWINGS

The following descriptions should not be considered limiting in any way. With reference to the accompanying drawings, like elements are numbered alike:

FIG. 1 depicts an element of a seal tool having soluble glass strands therein;

FIG. 2 depicts an element of a seal tool having soluble glass particles therein;

FIG. 3 depicts a cement or composite material with soluble glass particles and strands shown therein and to be understood to be both or alternative inclusion; and

FIG. 4 depicts a schematic section of cement in a tubular form that has been treated to include soluble glass strands that are oriented generally radially through the cement.

### DETAILED DESCRIPTION

A detailed description of one or more embodiments of the disclosed materials, apparatus and methods are presented herein by way of exemplification and not limitation with reference to the Figures.

Soluble glass in forms such as strands (threadlike members), particles, powders, beads, etc. is useful in the downhole environment due to its property of being initially fluid resistant yet dissolvable in water based fluids. Further, because the particular dissolution characteristics are adjustable based upon the chemistry of the glass during creation thereof, the material lends itself to many different needs easily. Soluble glass is discussed in the following articles, the entire contents of which are incorporated herein by reference: Viscosity profiles of phosphate glasses through combined quasi-static and bon-in-cup methods, Novel Phosphate Glasses for Bone Regeneration Applications, Grand Challenges in Glass Science, Effect of boron oxide addition on fibre drawing, mechanical properties and dissolution behavior of phosphate-based glass fibres with fixed 40, 45 and 50 mol % P2O5, Cytocompatibility and Mechanical Properties of Short Phosphate Glass Fibre Reinforced Polylactic Acid (PLA) Composites: Effect of Coupling Agent Mediated Interface. Any of the soluble glass disclosed in these publications or otherwise available may be used. Another type of soluble (or dissolvable) glass that may be employed as described herein is known colloquially as “water glass”. Water Glass comprises about 55 to about 80 wt. % of SiO₂, 0 to about 35 wt. % of Na₂O, 0 to about 35 wt. % of K₂O, 0 to about 20 wt. % of CaO, 0 to about 10 wt. % of MgO, provided that the sum of the weights of Na₂O and K₂O is about 20 wt. % to about 40 wt. %, wherein each weight percent is based on the total weight of the dissolvable glass.

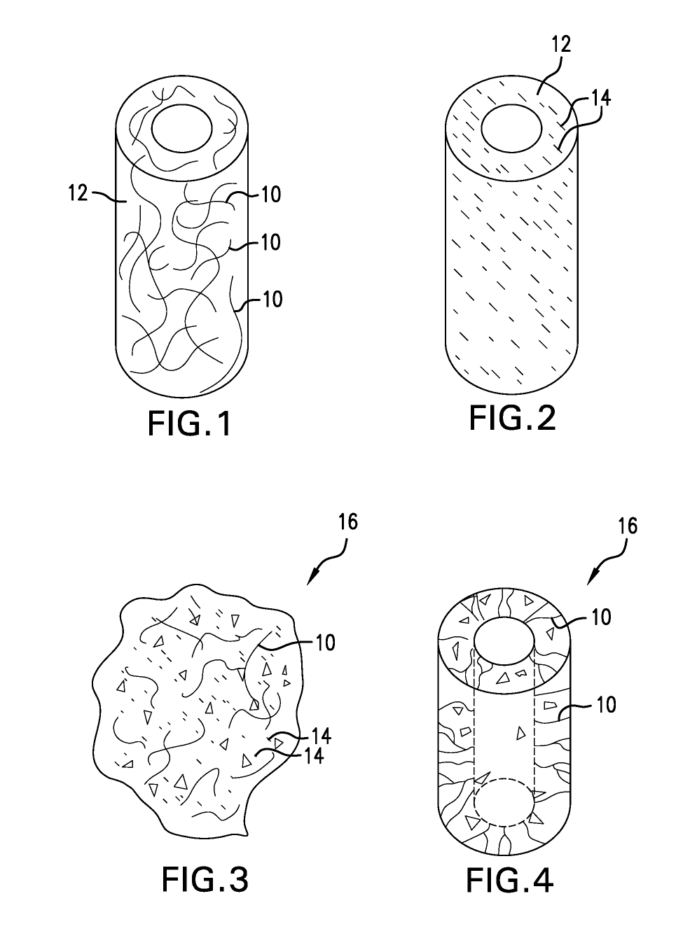

In one embodiment, referring to FIG. 1, soluble glass strands 10 are dispersed within a material 12 such as a seal element (e.g. a polymer, elastomer or rubber element) during formation of the element such that the strands become part of the element. The strands may be of any length and either a plurality of strands or a single long strand in various iterations. The element 12 will function the same as an element that did not have soluble glass therein would do for a period of time. That period of time is dictated by the particular chemistry of the soluble glass that has been included in the element 12. Accordingly, the seal may be set mechanically, by inflation, by swelling, etc. to provide a seal for whatever operation of which the seal is a part and then later at a time that was predetermined, the soluble glass will dissolve leaving the element structurally unsound. In some cases the element will stop forming a seal and in other cases the element may break apart. This will remove the element as an impediment to subsequent operations. This embodiment is particularly useful in combination with other dissolvable components of a well tool such as those using controlled electrolytic metallic material under the trade name InTallic™ from Baker Hughes Incorporated. Such components disintegrate in the borehole environment. Should sealing components remain intact, these components can in some cases become an impediment to other operations or to production/injection. The soluble glass will allow the element degrade and not become an impediment. The remnants of the element may either fall to the bottom of the borehole, may be circulated out, or produced during production as desired.

With reference to FIG. 2, another element 12 is illustrated this time with soluble glass particles 14 dispersed therein. The particles may be of any size and hence might be considered powder, beads, blobs, chunks, etc. In any event, the inclusion of the soluble glass particles 14 again allows the element to be used for its conventional purpose and set in any conventional way while after a selected period of time in contact with a water based fluid becoming structurally unsound based upon the dissolution of the glass 14. Depending upon the ratio of glass particles employed in the creation of the element, the remaining material of the element after dissolution may break apart and drift where gravity may dictate or may be entrained with fluid flow to another location. Alternatively, if the ratio of inclusion of the glass 14 is insufficient to actually cause the element to effectively self-destruct, it will still undermine structural integrity sufficiently to allow for easy removal of the element in another way, such as drilling.

In another embodiment hereof, referring to FIG. 3, soluble glass strands 10 and/or soluble glass particles 14 are dispersed in material 16 such as cement used for a cementing job in the borehole or a composite material. Jobs include but are not limited to casing cementing, plugs, etc. Upon the passage of the desired time after curing of the cement, the glass strands dissolve and produce a porous cement structure that has the capability of allowing fluid to flow therethrough. This can be useful for such operations as require fluid loss control or zone isolation early in the operation and later would be more beneficial to completing, producing the well, or injecting into the well, if the cement were porous/permeable. With this embodiment, both ideals are accomplished without additional intervention. In addition, in alternate embodiments, and depending upon the ratio of inclusion of soluble glass in the cement or composite material, dissolution of the soluble glass will ultimately cause the cement configuration to become structurally reduced in strength following soluble glass dissolution. This will facilitate its removal either by natural means (breaking apart and being entrained in the fluid flow or falling to the bottom of the borehole) or easier removal through active means such as drilling, if indeed a particular use requires removal of the cement or composite structure. While the latter requires another run, the drilling operation will be rapidly successful due to the lack of structural integrity of the cement after dissolution of the glass fill therein.

Referring to FIG. 4, a section of material such as a cement or composite material illustrated as a tubular but could be any shape, includes oriented strands of soluble glass 10 dispersed in the material 16. In the original condition, this embodiment would contain fluid under pressure but after a prescribed period of time related to soluble glass dissolution, the glass strands would dissolve leaving generally radially oriented openings through which fluid may pass. This can be useful in situations where a cementing job would require perforating guns to be used at the appropriate time. With the teaching of this disclosure, no guns would be needed as the fluid passages would open on their own in the prescribed time.

Methods for operating in a borehole include disposing a downhole tool of any of the types described above in a borehole; performing an operation in the borehole; allowing sufficient time for the soluble glass to dissolve; performing a different operation in the borehole without taking an action to change the tool or material.

In another aspect, soluble glass is added to one or more fluids such as mud, brines or fracturing fluids (which may include proppant) to provide for temporary plugging or to increase flow after installation when the soluble glass dissolves thereby leaving additional fluid pathways through the plug or frac pack, etc. More specifically, where soluble glass is initially added to any of the listed or similar fluids, the glass will initially occupy a portion of the volume occupied by the total combined fluid. Over time however, the glass will dissolve and thereby remove the volume previously occupied by that glass, leaving voids in its place that will act as fluid channels. FIG. 3 is applicable to this embodiment as it would look the same.

Set forth below are some embodiments of the foregoing disclosure:

Embodiment 1: A downhole material comprising a soluble glass dispersed within the material.

Embodiment 2: The downhole material of any of the preceding embodiments, wherein the material is a seal element.

Embodiment 3: The downhole material of any of the preceding embodiments, wherein the seal element includes an elastomer.

Embodiment 4: The downhole material of any of the preceding embodiments, wherein the material includes cement.

Embodiment 5: The downhole material of any of the preceding embodiments, wherein the material includes composite.

Embodiment 6: The downhole material of any of the preceding embodiments, wherein the soluble glass is configured as one or more strands.

Embodiment 7: The downhole material of any of the preceding embodiments, wherein the one or more strands comprise a single long strand.

Embodiment 8: The downhole material of any of the preceding embodiments, wherein the soluble glass is in the form of particles.

Embodiment 9: The downhole material of any of the preceding embodiments, wherein the particles are beads.

Embodiment 10: The downhole material of any of the preceding embodiments, wherein the one or more strands are oriented generally radially through a section of the material.

Embodiment 11: A method for operating in a borehole comprising: disposing a downhole material as claimed in claim 1 in a borehole; performing an operation in the borehole; allowing sufficient time for the soluble glass to dissolve; and performing a different operation in the borehole without taking an action to change the material.

Embodiment 12: A downhole fluid comprising: one or more fluid components; and soluble glass.

Embodiment 13: The downhole fluid of any of the preceding embodiments, wherein the one or more fluid components comprise mud.

Embodiment 14: The downhole fluid of any of the preceding embodiments, wherein the one or more fluid components comprise brine.

Embodiment 15: The downhole fluid of any of the preceding embodiments, further comprising proppant.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A downhole material comprising a soluble glass dispersed within the material.

2. The downhole material as claimed in claim 1 wherein the material is a seal element.

3. The downhole material as claimed in claim 2 wherein the seal element includes an elastomer.

4. The downhole material as claimed in claim 1 wherein the material includes cement.

5. The downhole material as claimed in claim 1 wherein the material includes composite.

6. The downhole material as claimed in claim 1 wherein the soluble glass is configured as one or more strands.

7. The downhole material as claimed in claim 6 wherein the one or more strands comprise a single long strand.

8. The downhole material as claimed in claim 1 wherein the soluble glass is in the form of particles.

9. The downhole material as claimed in claim 8 wherein the particles are beads.

10. The downhole material as claimed in claim 1 wherein the one or more strands are oriented generally radially through a section of the material.

11. A method for operating in a borehole comprising:
disposing a downhole material as claimed in claim 1 in a borehole;
performing an operation in the borehole;
allowing sufficient time for the soluble glass to dissolve; and
performing a different operation in the borehole without taking an action to change the material.

12. A downhole fluid comprising:
one or more fluid components; and
soluble glass.

13. The downhole fluid as claimed in claim 12 wherein the one or more fluid components comprise mud.

14. The downhole fluid as claimed in claim 12 wherein the one or more fluid components comprise brine.

15. The downhole fluid as claimed in claim 12 further comprising proppant.
